(19) United States
(12) Patent Application Publication
(10) Pub. No.: US 2023/0254805 A1
(43) Pub. Date: Aug. 10, 2023

(54) MOBILE TELECOMMUNICATIONS PLATFORM

(71) Applicant: Crime Scan Pty Ltd, Subiaco (AU)

(72) Inventor: Kris GAUNT, Subiaco (AU)

(73) Assignee: Crime Scan Pty Ltd, Subiaco (AU)

(21) Appl. No.: 17/882,107

(22) Filed: Aug. 5, 2022

(30) Foreign Application Priority Data
Aug. 5, 2021 (AU) 2021902427

(51) Int. Cl. H04W 64/00; H04B 7/185

(52) U.S. Cl. CPC H04W 64/00; H04B 7/18504

(57) ABSTRACT

A remote communications system comprises a mobile platform, a base station and a navigation station. The mobile platform comprises a cellular network base transceiver station; a location determining device; a first wireless transceiver; a first controller and a movement system for moving the mobile platform. The first controller is for receiving the location of the mobile platform from the location determining device, interfacing with the cellular network base transceiver station so as to control the cellular network base transceiver station and to act as a bridge between the cellular network base transceiver station and the wireless transceiver. The base station has a second wireless transceiver for communicating with the first wireless transceiver and a second controller for communicating with the controller via the second wireless transceiver. The second controller is arranged to control the first controller. The navigation station is for wirelessly controlling the movement system.

### FIELD OF THE INVENTION

The present invention relates to providing a telecommunications platform that is mobile.

### BACKGROUND

The following discussion of the background art is intended to facilitate an understanding of the present invention only. It should be appreciated that the discussion is not an acknowledgement or admission that any of the material referred to was part of the common general knowledge as at the priority date of the application.

Search and rescue operations often occur in remote and/or rugged terrain and/or bad weather. Often cellular telephone (mobile telephone) reception is poor or terrain dependent or non-existent in these circumstances. This hampers such search and rescue operations. Further, even if there is reception, often the telephone is only in range of a single tower making triangulation using two or three (or more) towers impossible. The reception range of a tower depends on the type of connection and conditions but can be up to 80 km, which may locate the phone within the reception area, or even a certain distance from the tower but this can still be a large area to search. Obviously when there is no reception at the location of the person the subject of the search, then location even to this extent is not possible. Additionally, lack of cellular telephone reception can also hamper efforts of those performing the search and rescue.

In other situations, such as in policing or security operations, finding a person even in an area with mobile reception can be difficult. IMSI Catcher devices can be used to find a particular telephone or to conduct interception of cellular telephone signals. Such a device must be installed for operation by an operator at a location, and manually operated. Thus, there are limitations even when there is good reception in such operations.

The present invention has been developed with one or more of these limitation in mind.

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

### SUMMARY OF THE INVENTION

According to an aspect disclosed there is a remote communications system comprising

a mobile platform comprising:

a cellular network base transceiver station;

a location determining device;

a first wireless transceiver;

a first controller for receiving the location of the mobile platform from the location determining device, interfacing with the cellular network base transceiver station so as to control the cellular network base transceiver station and to act as a bridge between the cellular network base transceiver station and the wireless transceiver; and

a movement system for moving the mobile platform;

a base station having a second wireless transceiver for communicating with the first wireless transceiver and a second controller for communicating with the controller via the second wireless transceiver, the second controller arranged to control the first controller; and a navigation station for wirelessly controlling the movement system.

In an embodiment the system further comprises one or more relays for relaying wireless signals between the first wireless transceiver and the second wireless transceiver. In an embodiment one or more of the relays are each provided on a further mobile platform. In an embodiment the first wireless transceiver is configured to operate as a relay between a third wireless transceiver mounted on another mobile platform and the second wireless transceiver.

In an embodiment the mobile platform comprises a camera arranged to provide a video signal to the first controller.

In an embodiment the cellular network base transceiver station is configured to act as a cellular network (eg. GSM, LTE, UMTS, 4G, 5G etc.) interface capable of interfacing with existing cellular network infrastructure.

In an embodiment the cellular network base transceiver station is configured to communicate with a cellular telephone. In an embodiment the communication with the cellular telephone have the full capabilities with the cellular telephone that a tower of the existing cellular network infrastructure would have. In an alternative the communication with the cellular telephone is limited, such as receiving the registration request from the cellular telephone. The cellular network base transceiver station may be configured to interact with a specific cellular telephone, eg. by looking for a specific telephone number or a specific International Mobile Equipment Identity (IMEI). In an embodiment the cellular network base transceiver station is configured to act as a virtual base transceiver station. In an embodiment the cellular network base transceiver station is configured to act as an International Mobile Subscriber Identity (IMSI) Catcher. In an embodiment the cellular network base transceiver station is implemented with a Smith Myers ARTEMIS system.

The cellular network base transceiver station controlled to report on all of the cellular telephones is able to communicate with (by analogy, report on all of the cellular telephones ‘it can see’).

In an embodiment the cellular network base transceiver station is arranged to provide signal strength information to the controller. In an embodiment the controller and/or the cellular network base transceiver station is configured to determine a location of the cellular telephone based on the signal strength information and the location of the mobile platform. Preferably the location is determined by moving of the mobile platform and triangulation of distances to the cellular telephone at different locations. Alternatively, the cellular network base transceiver station comprises a plurality of antenna and the signal strength received at each antenna is used to determine the location of the cellular telephone.

In an embodiment the first and second transceivers use one or more of: a cellular telephone network, a wireless mesh network, a microwave communication network.

In an embodiment the first and second transceivers are configured as a Mobile Networked Multiple Input Multiple Output network.

In an embodiment the mobile platform comprises a power supply for the cellular network base transceiver station, location determining device, first wireless transceiver and first controller independent from the power supply to the movement system.

In an embodiment the movement system comprises a radio control communication channel independent from the cellular network base transceiver station and first wireless transceiver.

In an embodiment the first wireless transceiver is able to communicate with one or more third devices. For example, emergency/first responder/security devices. The first wireless transceiver relays the third device(s) to the second transceiver.

In an embodiment the location determining device comprises a GPS receiver.

According to another aspect disclosed there is provided a device mountable on a mobile platform, the device comprising

a cellular network base transceiver station;

a location determining device;

a first wireless transceiver;

a first controller for receiving the location of the mobile platform from the location determining device, interfacing with the cellular network base transceiver station so as to control the cellular network base transceiver station and to act as a bridge between the cellular network base transceiver station and the wireless transceiver; and

a power supply independent of the mobile platform's power supply.

According to another aspect disclosed there is provided a mobile platform in the form of an unmanned aerial vehicle (UAV) comprising the device mounted on the UAV.

In an embodiment the UAV is a vertical take-off and landing (VTOL) rotor powered aircraft (otherwise known as a drone).

In an embodiment the UAV is remotely piloted. In an embodiment the remote piloting is by signal transmitted to the UAV independently of the cellular network base transceiver station and the first wireless transceiver.

According to another aspect disclosed there is provided a method of communication comprising

receiving at a cellular network base transceiver station mounted on a mobile platform a signal from a cellular telephone;
bridging the signal to a first wireless transceiver mounted on the mobile platform;
transmitting the signal to a base station via the first wireless transceiver.

According to another aspect disclosed there is provided a method of location of a person carrying a cellular telephone, the method comprising:

positioning a mobile platform in a search area;
sending a cellular telephone carrier signal into the search area;
listening for a response from the cellular telephone;
in the event of a response establishing a connection between the cellular telephone and a wireless transceiver.

In an embodiment sending the cellular telephone carrier signal into the search area is performed by a cellular network base transceiver station mounted on the mobile platform.

In an embodiment the connection between the cellular telephone and the wireless transceiver is via the cellular network base transceiver station, a first wireless transceiver mounted on the mobile platform and a bridge between the cellular network base transceiver station and the first wireless transceiver.

In an embodiment the connection between the cellular telephone and the cellular network base transceiver station is used to triangulate the cellular telephone with respect to one or more known positions of the mobile platform. The position of the mobile platform is preferably known by use of a location device (eg. GPS receiver) mounted on the mobile platform.

In an embodiment in the event of there being no response received from the cellular telephone the mobile platform is repositioned.

In an embodiment the positioning and repositioning dynamically occur as the mobile platform is moving through the search area.

According to an aspect disclosed there is provided a communication system comprising a cellular telephone transceiver, a wireless data transceiver and a network bridge connecting the cellular telephone transceiver and the wireless data transceiver.

According to an aspect disclosed there is provided a package comprising a housing shaped and sized to receive a cellular telephone transceiver and a wireless data transceiver therein, openings in the housing for providing heatsinks of one or both of the cellular telephone transceiver and the wireless data transceiver to receive atmospheric ventilation, mounting provision for antenna of the cellular telephone transceiver and the wireless data transceiver, a power supply connector for connector to and for mounting a power source, and a coupling for connection of the housing to a mobile platform.

### DESCRIPTION OF DRAWINGS

In order to provide a better understanding, embodiments will be descried in relation to the accompanying drawings, in which:

FIG. 1 is a schematic block diagram of a mobile communications platform according to an embodiment of the present invention;

FIG. 2 is a schematic flow diagram of use of a mobile communications platform according to an embodiment of the present invention;

FIG. 3 is a schematic flow diagram of a search and rescue process using a mobile communications platform according to an embodiment of the present invention;

FIG. 4 is a schematic exploded view of components of a mobile communications system according to an embodiment of the present invention;

FIG. 5 is an isometric view of a package for components of a mobile communications platform according to an embodiment of the present invention;

FIG. 6 is an isometric view of a UAV for mounting of the package of FIG. 5;

FIG. 7 is a first isometric view of the UAV of FIG. 6 with the package of FIG. 5 mounted thereon;

FIG. 8 is a second isometric view of the UAV of FIG. 6 with the package of FIG. 5 mounted thereon;

FIG. 9 is a first isometric view of the package of FIG. 5 with antenna mounted thereon;

FIG. 10 is a second isometric view of the package of FIG. 5 with antenna mounted thereon; and

FIG. 11 is an exploded isometric view of the components of FIG. 4 and the package of FIG. 5.

### DETAILED DESCRIPTION OF EMBODIMENTS

Broadly there is a mobile platform mounted communication system able to move via the mobile platform as required, able to communicate with cellular telephones as a cellular network base transceiver station and able to bridge the communications to a different wireless network.

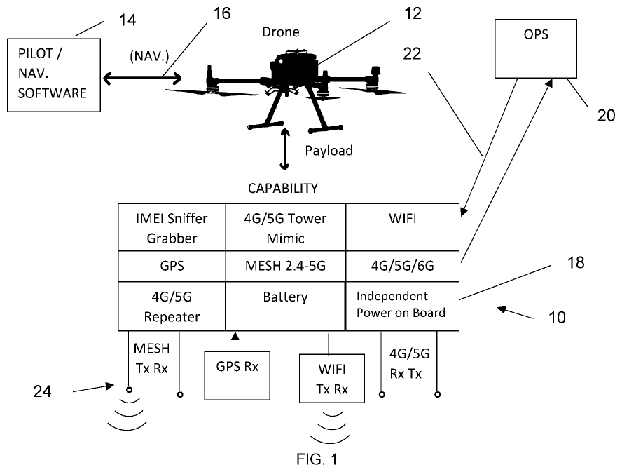

Referring to FIG. 1, in this example, the mobile platform is a UAV 12 (commonly called a drone) which is able to fly under control of a pilot or navigation software 16 by rotors 414 (in FIG. 7) providing lift and propulsion trust in a known manner. DVI is commonly known manufacturer of such drones. The pilot provides control via a navigation station.

It is common for a camera 416 to be mounted on the drone 12 and for it to have a flight control system 412 controlling electric motors powering the rotors 414. The pilot or navigation software 14 communicates with the flight control system 412 using standard wireless radio communication 16. The drone 12 carries a payload 18 which comprises the mobile platform mounted communication system (comms system) of the present invention. The comms system communicates with operations personnel via an operations system 20 and a secure wireless communication channel 22.

In the embodiment shown in FIG. 1, the comms system comprises a plurality of interconnected, wireless communication modules which communicate by a plurality of wireless communication channels 24 with external devices. Communication channel 22 may be one of the channels 24. Preferably communication 16 is independent of channel 22 and channel 24. The comms system comprises a cellular network transceiver 30 for communication 44 with a cellular telephone 42.

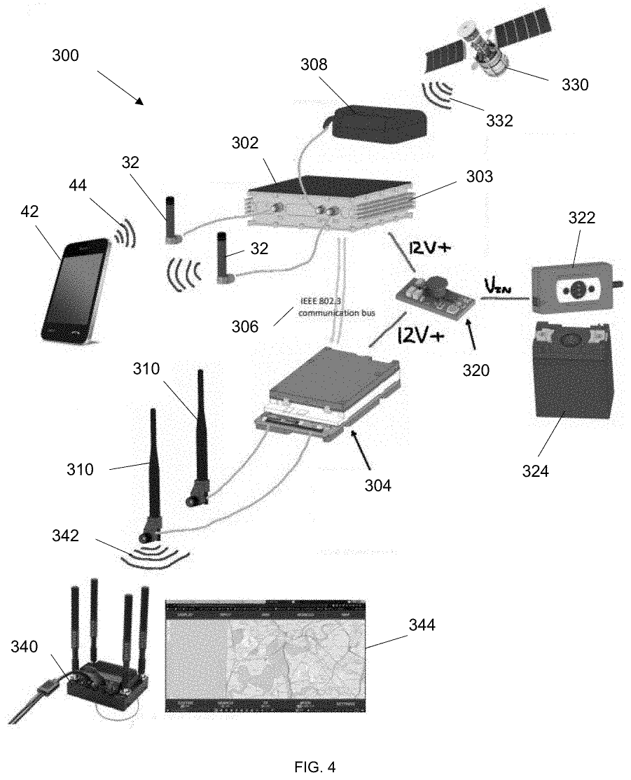

In the embodiment shown in FIG. 4, the comms system comprises a cellular network base transceiver station 302, a first wireless transceiver 304, a communication bridge 306 between the cellular network base transceiver station 302 and the first wireless transceiver 304, a location determining device 308, and a power supply for the comms system.

In an embodiment the cellular network base transceiver station 302 is configured to act as a cellular network (eg. GSM, UMTS, 3G, LTE, 4G, 5G etc.) interface capable of interfacing with existing cellular network infrastructure.

Preferably the cellular network base transceiver station 302 comprises the cellular network transceiver 30 and is arranged to imitate or perform aspects of a fixed cellular network base transceiver station tower and/or an IMEI sniffer/grabber. The functionality is preferably to at least detect a cellular phone, initiate a response such as a handshaking exchange so be able to range find from signal strength, and more preferably be able to communicate such as by message (eg. SMS), telephone or data transfer. The cellular network base transceiver station 302 is connected (such as with cable, for example RG316 coaxial cable) to at least one, preferably two antennae 32, such as wide frequency stubby antennae, that transmit and receive signals 44 to/from a cellular telephone 42. An example of the cellular network base transceiver station 302 is a processor box which may be a Smith Myers ARTEMIS system. Alternatives are possible.

Preferably the first wireless transceiver 304 comprises one or more of a WIFI network node, and/or a mesh network node, and/or cellular telephone network (eg. GMS, UMTS, 3G, LTE, 4G or 5G) node.

In the embodiment of FIG. 4, the preferred form of the transceiver 304 is the mesh network node although other types may be used instead or in addition. Preferably the mesh network is a Mobile Networked wireless mesh network, with Multiple Input Multiple Output (MIMO). The transceiver 304 is connected (preferably by a cable, such as RG316 coaxial cable) to at least one, preferably two antennae 310, such as omni-directional antenna. In one example, the transceiver 304 is preferably a Silvus Technologies Radio. The transceiver 304 communicates via a signal 342 with a base station 340, possibly via one or more relays, possibly meshed relays and/or via a plurality of base stations and other networks.

Preferably the power supply is independent of the power supply of the drone 12. In this embodiment the power supply comprises a battery 324. Preferably the battery is a high density battery, such as a 10.8V 72 Wh lithium ion battery. The battery preferably has an interlock connection, such as one that has a twist engagement. The battery is connected to a connector 322. Preferably the connector 322 has a mating bar that interacts with the twist interlock and connector pins that contact with the battery's pins when locking in position.

The power supply may have a power conditioner 320, in case example a DC-DC booster which boosts the battery voltage to the required voltage, of for example 12V DC.

The comms system further comprises a receiver for receiving the location of the mobile platform, such as a GPS receiver 308 that receives a signal 332 from global positioning satellites 330. The GPS receiver 308 is preferably independent of any GPS receiver the drone 12 may have. The GPS receiver 308 is preferably connected to the station box 302 preferably by a cable, such as RG316 coaxial cable.

Preferably the comms system comprises a controller for controlling the operation of the comms system and in particular the cellular network base transceiver station 302. Preferably the controller is provided by a processor of the station box 302 and an interface application access via the first wireless network connection to a base station 340 via an operator interface 344.

The bridge between the cellular network base transceiver station 302 and the first wireless transceiver 304 is preferably an IEEE802.3 communication bus 306, with for example an Ethernet cable.

Preferably the base station 340 has a second wireless transceiver for communicating with the first wireless transceiver 304 and a second controller (which for example implements the user interface 344) for communicating with the controller on the cellular network base transceiver station 302 via the second wireless transceiver.

In an embodiment the communication to the base station 340 is via one or more relays for relaying wireless signals between the first wireless transceiver 304 and the second wireless transceiver. In an embodiment one or more of the relays are each provided on a further mobile platform. In an embodiment the first wireless transceiver is configured to operate as a relay between a third wireless transceiver mounted on another mobile platform and the second wireless transceiver.

In an embodiment the mobile platform comprises a camera arranged to provide a video signal to the first controller. In an embodiment the video signal is configured with the Milestone video management software.

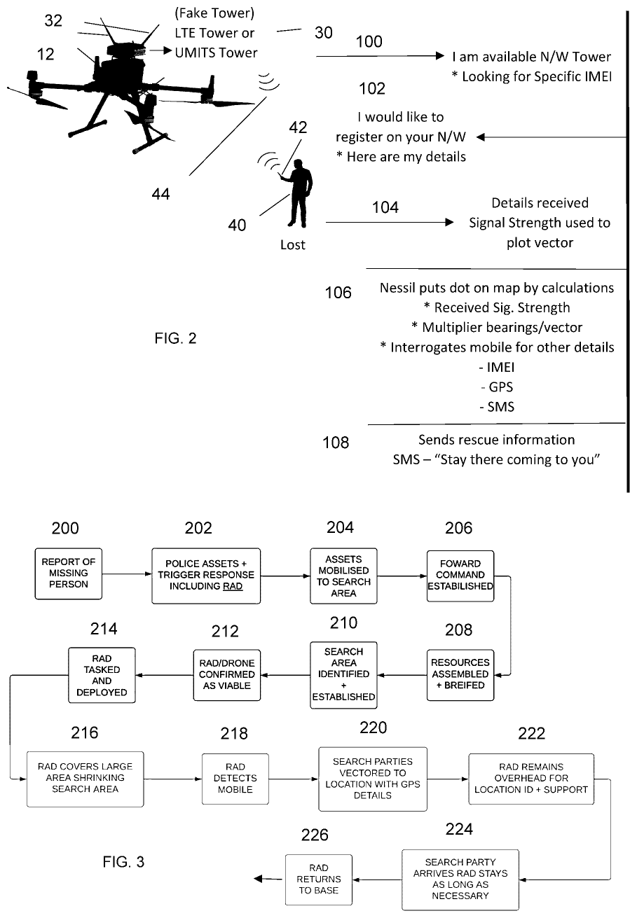

Referring to FIG. 2, in an embodiment the cellular network transceiver 30 is configured to communicate 44 with the cellular telephone 42. In an embodiment the communication with the cellular telephone 42 has the full capabilities with the cellular telephone 42 that a tower of the existing cellular network infrastructure would have. In an alternative the communication with the cellular telephone 42 is limited, such as receiving the registration request from the cellular telephone. The cellular network base transceiver station may be configured to interact with a specific cellular telephone, eg. by looking for a specific telephone number or a specific International Mobile Equipment Identity (IMEI). In an embodiment the cellular network transceiver 30 is configured to act as a virtual base transceiver station. In an embodiment the cellular network base transceiver station is configured to act as an International Mobile Subscriber Identity Catcher.

The cellular network transceiver 30 is controlled to report on all of the cellular telephones is able to communicate with (by analogy, report on all of the cellular telephones ‘it can see’).

In an embodiment the cellular network base transceiver station 302 is arranged to provide signal strength information to the controller. In an embodiment the controller and/or the cellular network base transceiver station 302 is configured to determine a location of the cellular telephone based on the signal strength information and the location of the mobile platform. Preferably the location is determined by moving of the mobile platform and triangulation of distances to the cellular telephone at different locations. Alternatively, the cellular network base transceiver station comprises a plurality of antenna and the signal strength received at each antenna is used to determine the location of the cellular telephone.

The cellular network transceiver 30 transmits 100 a signal indicating it is available for a cellular telephone connection (as a tower does). If received the cellular telephone 42 transmits 102 a response to register with the ‘tower’ and provides identification details, such as IMEI. The transceiver 30 acknowledges 104 the details. In an embodiment the processor uses the signal strength to determine a distance and may change of position and/or by use of multiple antenna may also determine a signal direction. From the direction, distance and current position the processor may be able to plot 106 a position of the cellular telephone on a map.

When the user 40 of the cellular phone 42 is lost or otherwise being searched for the plotted position can be relayed to search and rescue/first responders for assistance. Communication 108 with the user 40 can be initiated, such as by SMS, or otherwise (eg telephone call).

When the processor box 302 is a Smith Myers ARTEMIS system, it may have the following capabilities: audio and text connection to the telephone 40 with a range in the order of 30 km. Transmission on a single cellular network frequency using GSM, UMTS or LTE. Range and direction finding with two antenna. Calculation of Lat. And Long. based on input GPS location of the UAV. Location of multiple cellular telephones is possible.

FIG. 3 shows an example process finding a missing person in possession of a cellular telephone. At 200 the person is reported missing. At 202 a response is triggered. At 204 assets are mobilized to a search area. At 206 a forward command may be established. At 208 resources may be assembled and briefed. At 210 a search area is defined for the rapid assistance drone (RAD) to traverse. At 212 the RAD is prepared (eg fresh battery connected) and at 214 tasked (powered up and software started) and deployed. At 216 the RAD flies the search area ‘looking for’ the cellular telephone 40. At 218 the RAD detects the cellular telephone 40 and determines its position. At 220 the position of the cellular phone is communicated to a ‘base’ and then to search parties. At 222 the RAD remains overhead for location identification and support (eg. providing a commination node for the search party and the found person). At 224 the search party arrives. At 226 when no longer needed the RAD returns from deployment.

Communication from the cellular telephone comprises receiving a signal from a cellular telephone at a cellular network base transceiver station mounted on the mobile platform. The signal may be processed by for example determining the position of the cellular telephone. Commination (such as text or voice) is bridged to a first wireless transceiver mounted on the mobile platform and then transmitted a base station via the first wireless transceiver.

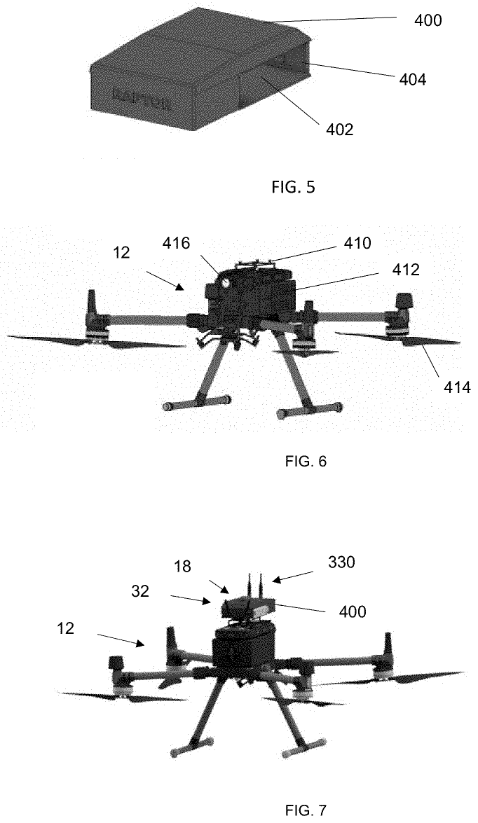

Referring to FIG. 5 the comms system is mounted inside a package 400 that is mounted on the UAV 12. In an example the package may be made of suitable light weight and preferably strong material such as plastic or carbon fibre. The housing has an interior 402 for receiving the cellular telephone transceiver 302 and a wireless data transceiver 304 and one or more openings 404 for allowing heatsinks of one or both of the cellular telephone transceiver and the wireless data transceiver to protrude so as to receive atmospheric ventilation.

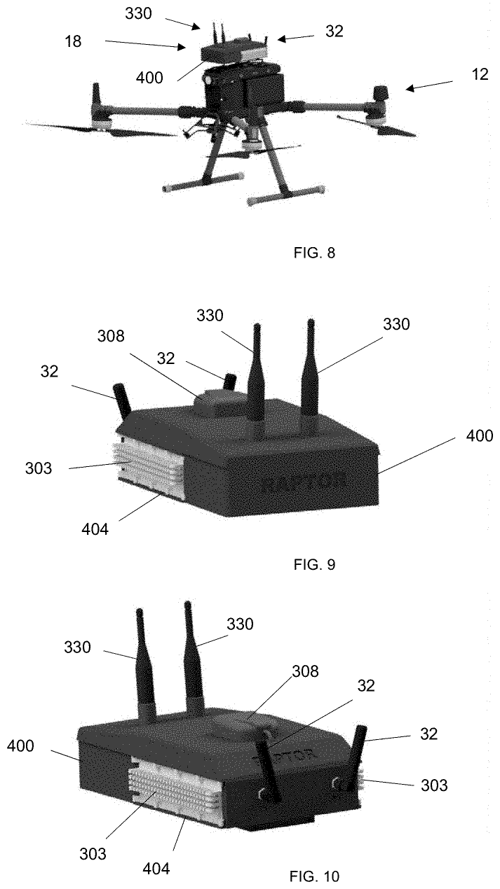

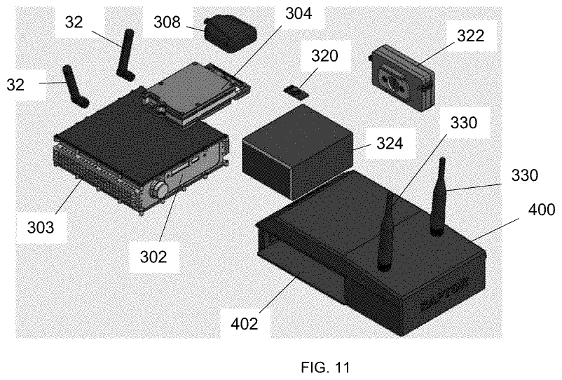

The UAV 12 is provided with a coupling 410 for connection of the package 400 as shown in FIG. 6. It is shown mounted in FIG. 7 and FIG. 8.

The housing 400 has mounting provision for antenna 330 of the cellular telephone transceiver and the wireless data transceiver 32. The housing 400 has mounting provision for the GPS receiver 308.

The housing 400 also has provision for the power supply connector 332 for connector to and for mounting the battery 324. The housing 400 may also hold another battery which can be used to keep power while the battery 324 is swapped (allow hot swapping) and also to permit return to base or as a last resort safe emergency decent.

Modifications may be made to the present invention within the context of that described and shown in the drawings. Such modifications are intended to form part of the invention described in this specification.

1. A remote communications system comprising
a mobile platform comprising:
a cellular network base transceiver station;
a location determining device;
a first wireless transceiver;
a first controller for receiving the location of the mobile platform from the location determining device, interfacing with the cellular network base transceiver station so as to control the cellular network base transceiver station and to act as a bridge between the cellular network base transceiver station and the wireless transceiver; and
a movement system for moving the mobile platform;
a base station having a second wireless transceiver for communicating with the first wireless transceiver and a second controller for communicating with the controller via the second wireless transceiver, the second controller arranged to control the first controller; and
a navigation station for wirelessly controlling the movement system.

2. The remote communications system according to claim 1, wherein system further comprises one or more relays for relaying wireless signals between the first wireless transceiver and the second wireless transceiver.

3. The remote communications system according to claim 2, wherein one or more of the relays are each provided on a further mobile platform.

4. The remote communications system according to claim 1, wherein the first wireless transceiver is configured to operate as a relay between a third wireless transceiver mounted on another mobile platform and the second wireless transceiver.

5. The remote communications system according to claim 1, wherein the cellular network base transceiver station controlled to report on all of the cellular telephones is able to communicate with.

6. The remote communications system according to claim 1, wherein the cellular network base transceiver station is arranged to provide signal strength information to the controller.

7. The remote communications system according to claim 6, wherein the controller and/or the cellular network base transceiver station is configured to determine a location of the cellular telephone based on the signal strength information and the location of the mobile platform.

8. A device mountable on a mobile platform, the device comprising
a cellular network base transceiver station;
a location determining device;
a first wireless transceiver;
a first controller for receiving the location of the mobile platform from the location determining device, interfacing with the cellular network base transceiver station so as to control the cellular network base transceiver station and to act as a bridge between the cellular network base transceiver station and the wireless transceiver; and
a power supply independent of the mobile platform's power supply.

9. A mobile platform in the form of an unmanned aerial vehicle (UAV) comprising the device according to claim 8 mounted on the UAV.

10. A method of communication comprising
receiving at a cellular network base transceiver station mounted on a mobile platform a signal from a cellular telephone;
bridging the signal to a first wireless transceiver mounted on the mobile platform;
transmitting the signal to a base station via the first wireless transceiver.

11. A method of location of a person carrying a cellular telephone, the method comprising:
positioning a mobile platform in a search area;
sending a cellular telephone carrier signal into the search area;
listening for a response from the cellular telephone;
in the event of a response establishing a connection between the cellular telephone and a wireless transceiver.

12. The method according to claim 11, wherein sending the cellular telephone carrier signal into the search area is performed by a cellular network base transceiver station mounted on the mobile platform.

13. The method according to claim 11, wherein the connection between the cellular telephone and the wireless transceiver is via the cellular network base transceiver station, a first wireless transceiver mounted on the mobile platform and a bridge between the cellular network base transceiver station and the first wireless transceiver.

14. The method according to claim 11, wherein the connection between the cellular telephone and the cellular network base transceiver station is used to triangulate the cellular telephone with respect to one or more known positions of the mobile platform.

15. The method according to claim 11, wherein in the event of there being no response received from the cellular telephone the mobile platform is repositioned.

16. The method according to claim 15, wherein the positioning and repositioning dynamically occur as the mobile platform is moving through the search area.
